(19) United States
(12) Patent Application Publication
(10) Pub. No.: US 2008/0178772 A1
(43) Pub. Date: Jul. 31, 2008

(54) Debris Catcher

(76) Inventor: Brad Roach, Brampton (CA)

Correspondence Address: QUICKPATENTS, INC., 32861 CALLE PERFECTO, SUITE A, SAN JUAN CAPISTRANO, CA, 92675, US

(21) Appl. No.: 11/862,880

(22) Filed: Sep. 27, 2007

Related U.S. Application Data
(60) Provisional application No. 60/897,815, filed on Jan. 29, 2007.

(51) Int. Cl. B43L 19/00

(52) U.S. Cl. 108/26

(57) ABSTRACT

A debris catcher for catching crumbs or debris is disclosed. The debris catcher comprises a “U” or “V” shaped trough having at least one flexible laterally-resilient sidewall that can be fixed in a gap between two kitchen appliances, such as an appliance or kitchen counter. The sidewalls of the debris catcher may be temporarily pressed towards each other to fit between the two objects and then released to hold the debris catcher in place. Once released the debris catcher springs apart and seals the gap between the two kitchen objects. Protective lips constructed on both ends of the debris catcher prevent crumbs, debris or liquids from falling out inadvertently.

### CROSS-REFERENCE TO RELATED APPLICATIONS

This application claims the benefit of U.S. Provisional Patent Application 60/897,815 filed Jan. 29, 2007.

### STATEMENT REGARDING FEDERALLY SPONSORED RESEARCH AND DEVELOPMENT

Not Applicable.

1. Field of the Invention

This invention relates to an appliance for catching debris on a kitchen table or countertop. More particularly, the present invention is related to a crumb or debris catcher comprises a “U” or “V” shaped trough having at least one flexible laterally resilient sidewall that can be fixed in a gap between two kitchen appliances such as an appliance and a kitchen table or a counter.

2. Discussion of Related Art

Housework is a time consuming and sometimes a painstaking part of one's daily routine. Normally, in the course of conducting work in kitchen, kitchen tables and counters become littered with debris like breadcrumbs, vegetable cuttings, etc. Much cleaning has to be done following food preparation work in a kitchen, even after a simple task such as cutting bread or slicing a cabbage. It is often difficult to gather all the crumbs spread around the kitchen table, countertops and the kitchen floor.

Debris or crumb collectors and receptacles that are currently used in the collection of materials are typically moveable and handheld, such as a conventional dustpan. Such devices engage target surfaces in a substantially parallel orientation through a sloped or contoured moveable collection receptacle to collect crumbs, dust or other refuse. The disposition of waste trimmings has been left up to the user, and no provision has been made to make this disposition easier, more efficient, neater, or less unattractive.

One prior art taught in U.S. Patent Appln No. 2005/0279749 to Karrasch et al. on Dec. 22, 2005 teaches a stationary, crumb catcher, recessed refuse collector and receptacle apparatus which is compatible with common household and office, hand held sweeping, dusting, and collecting devices. The apparatus forms a recessed container with a raised lip for refuse collection and removal and can be mounted to a target, horizontal surface including floors, tables, and countertops. Such a device must be manually manipulated each time it is used.

In another prior art device, taught in U.S. Pat. No. 4,802,595 to Northington on Feb. 7, 1989, a trough for attachment to the edge of a draftsman's table receives debris such as that generated by erasers, etc. The trough is adjustable in length, supported by brackets and removable from the brackets so the debris may be emptied into a waste receptacle. However screws are essential to fix this trough to the desk.

In another prior art device, taught in 2004/0120607 to Goren, Richard H on Jun. 24, 2004, a self-contained dust and debris catcher includes a single piece of material capable of being folded into a pouch-like configuration to receive dust and debris. The single piece of material includes a front adhesive component on the lower edge of the front surface and a rear adhesive component on the back surface. The front adhesive component is folded to form two sections which adhere forming the pouch-like configuration bounded by the sections of the lower edge of the front surface and the front surface, and the rear adhesive component is pressed against a surface where work is occurring. However, such a device is not well suited for repeated use in kitchen.

Therefore, there is a need for an improved debris catcher that facilitates more convenient cleaning within a kitchen environment. Such a needed device would be easy to empty, and easy to move and use in a variety of locations. Such a needed invention would also be reusable and relatively inexpensive to manufacture. The present device achieves these objectives.

### SUMMARY OF THE INVENTION

The present invention is an appliance for catching crumbs or debris. The crumb or debris catcher in accordance with features of the present invention comprises a “U” or “V” shaped trough having a pair of flexible laterally resilient sidewalls that can be fixed in a gap between two objects, such as kitchen appliances or counters.

An outermost portion of each resilient sidewall preferably includes a high-friction surface, a magnetic attachment means, or the like, whereby the sidewalls press against the objects and hold the debris catcher substantially in place between the two objects. These sidewalls may be temporarily pressed towards each other to fit between the two appliances and then released to frictionally and/or magnetically hold the debris catcher in place. Once released the debris catcher springs apart to present a trough for catching the debris by gravity.

Further the sidewalls preferably taper in thickness from a larger thickness towards the center of the trough to a thinner thickness towards each outermost portion to ensure that the lower portion of the debris catcher walls do not prematurely contact each other when inserted into the gap between the kitchen appliances. The debris catcher seals the gap between two kitchen appliances, cabinets, or the like.

Protective lips constructed on both edges of the debris catcher can be provided to prevent crumbs, debris or liquids from falling out and onto the floor. During kitchen use, the user can wipe crumbs or any other debris from a countertop and into the debris catcher, thereby simplifying kitchen cleaning.

To empty the debris catcher the trough can be squeezed and pulled out horizontally. After the front edge projects by some distance beyond the surface of the kitchen appliance the projected edge of the trough can be pushed down by hand, creating a slight incline downwards. Crumbs can be wiped off the bottom of the trough to a garbage bin placed on a floor underneath the debris catcher, or the whole unit can be removed and emptied into the garbage bin.

The present invention is a debris catcher that facilitates more convenient cleaning within a kitchen environment. The present device is easy to empty, and easy to move and use in a variety of locations. The present invention is also reusable and relatively inexpensive to manufacture. Other features and advantages of the present invention will become apparent from the following more detailed description, taken in conjunction with the accompanying drawings, which illustrate, by way of example, the principles of the invention.

### DESCRIPTION OF THE DRAWINGS

FIG. 1 illustrates an isometric view of a debris catcher of the present invention;

FIG. 2 illustrates a top plan view of the debris catcher of FIG. 1, as secured between a kitchen appliance and a kitchen counter;

FIG. 3 illustrates a front elevation view of the debris catcher of FIG. 1, as secured between the kitchen appliance and the kitchen counter of FIG. 2;

FIG. 4 illustrates a front elevation view of the debris catcher of FIG. 1 as squeezed and released between the kitchen appliance and the kitchen counter of FIG. 2, the phantom outlines showing the normal un-compressed position of the sidewalls of the debris catcher;

FIG. 5 illustrates a partial exploded view of an alternate telescopic version of the debris catcher;

FIG. 6 illustrates a front elevational view of an alternate V-shaped embodiment of the invention;

FIG. 7 illustrates a perspective view of the alternate embodiment of FIG. 6;

FIG. 8 illustrates a side-elevational view of another alternate embodiment of the invention; and

FIG. 9 illustrates a perspective view of the embodiment of FIG. 8.

### DETAILED DESCRIPTION OF THE PREFERRED EMBODIMENT

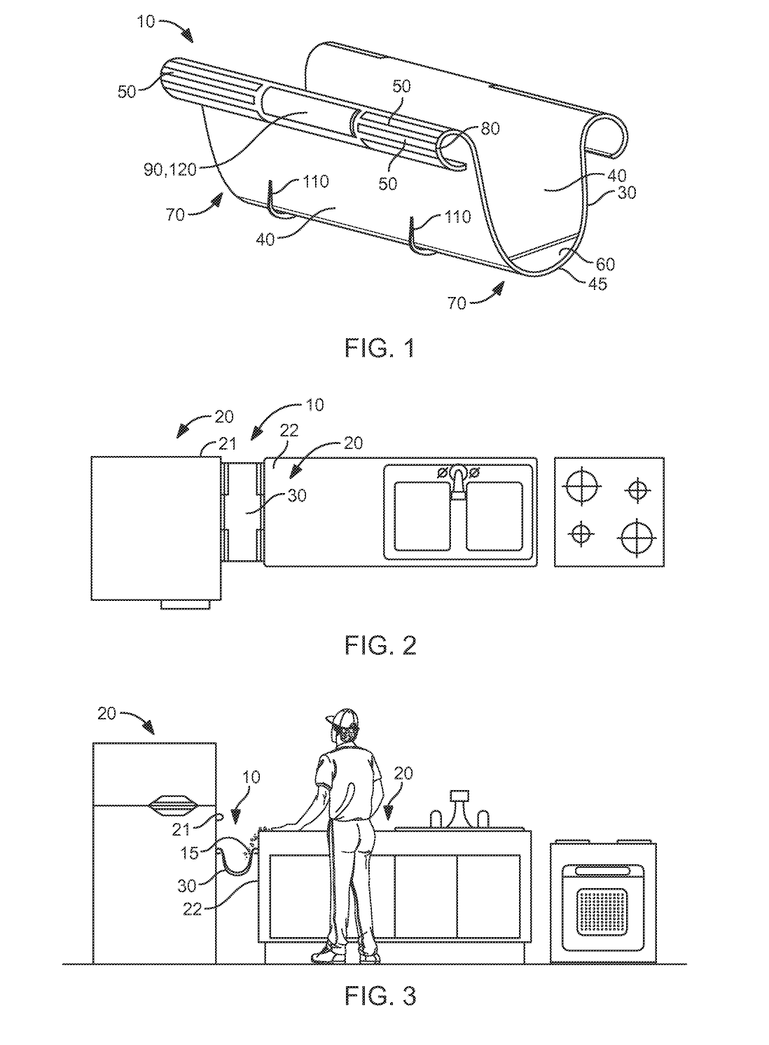

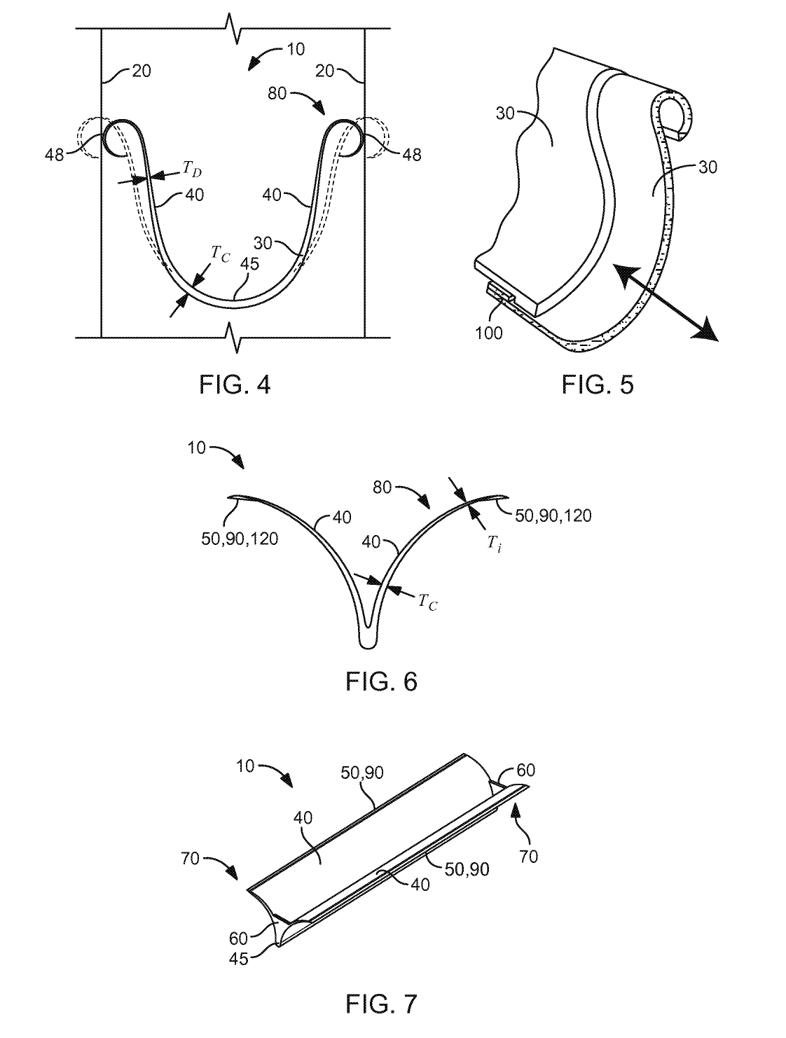

Referring to FIG. 1, illustrated is an isometric view of a debris catcher 10 in accordance with features of the present invention. Debris catcher 10 comprises a trough 30 having at least one laterally resilient sidewall 40. The sidewalls 40 can be pressed towards each other temporarily to fit the debris catcher 10 between two objects and then released to contact the objects and thereby hold the debris catcher 10 in place. One or both sidewalls 40 may include at least one high friction surface 50, such as a rubber pad, on an outermost portion 48 for frictionally contacting the object 20 (FIG. 4). The trough 30 may also include a pair of lips 60 at two ends 70 thereof to retain the debris 15 within the trough 30. An outwardly curved or bent section 80 on a portion of one or both sidewalls 40 can be provided for facilitating contacting of the objects 20.

The outermost portion 48 of one or both sidewalls 40 can also include a magnetic attachment means 90 whereby the outermost portion 48 of each sidewall 40 contacts the object 20 to frictionally and/or magnetically hold the debris catcher 10 substantially in place between the two objects 20. Each sidewall 40 further includes stiffening sections 110 proximate the center of the trough 30 for decreasing the resiliency towards the center 45 (FIG. 1). Protective padding means 120 can also be fixed to the outermost portion 48 of one or both sidewalls 40 to protect appliances and counter surfaces from scratching. Such padding means 120 may be a fabric pad, or the like.

FIGS. 2 and 3 illustrate the debris catcher 10 of FIG. 1, as secured between two kitchen objects 20. Debris catcher 10 is inserted between the two kitchen objects 20, and the trough 30 is firmly held in place therebetween. The two kitchen objects 20 may be a refrigerator 21 and a kitchen counter 22, for example.

FIG. 4 illustrates a close-up front elevation view of the debris catcher appliance 10 of FIG. 1, as squeezed between two kitchen objects 20. One or both sidewalls 40 of the debris catcher 10 may taper in thickness from a larger thickness T_{c} towards the center 45 of the trough 30 to a thinner thickness T_{b} towards each outermost portion 48. As such, the upper portion of the debris catcher walls 40 flex towards each other when inserted into the gap between the kitchen objects 20.

FIG. 5 illustrates a partial, exploded view of an alternative telescopic version of the debris catcher 10. In such an embodiment, trough 30 may include a connecting means 100, such as two lips, so that the debris catcher 10 may be connected coaxially to another such debris catcher 10 to extend the effective debris collection length. Connecting means 100 can also be provided with the ability to prevent the extension of the trough 30 beyond a maximum length, preventing inadvertent disassembly of the debris catcher 10 into two separate units. Clearly other connecting means 100 may be utilized to allow multiple debris catchers 10 to be connected together to form a longer form of the invention.

FIG. 6 illustrates a front elevational view of an alternate embodiment of the present invention. In this embodiment the trough 30 of the debris catcher 10 is substantially V-shaped in cross section. The upper edges 48 can include the high friction surface 50 and/or a magnetic attachment means 90 to contact the objects 20 frictionally and/or magnetically, and to hold the debris catcher 10 substantially in place between the two objects 20. The center area 45 of the trough 30 can be thicker than the outermost portions 48 for ensuring that the sidewalls 40 flex together towards the top thereof, and for providing strength to the debris catcher 10. FIG. 7 illustrates a similar embodiment that also includes the sidewalls 40.

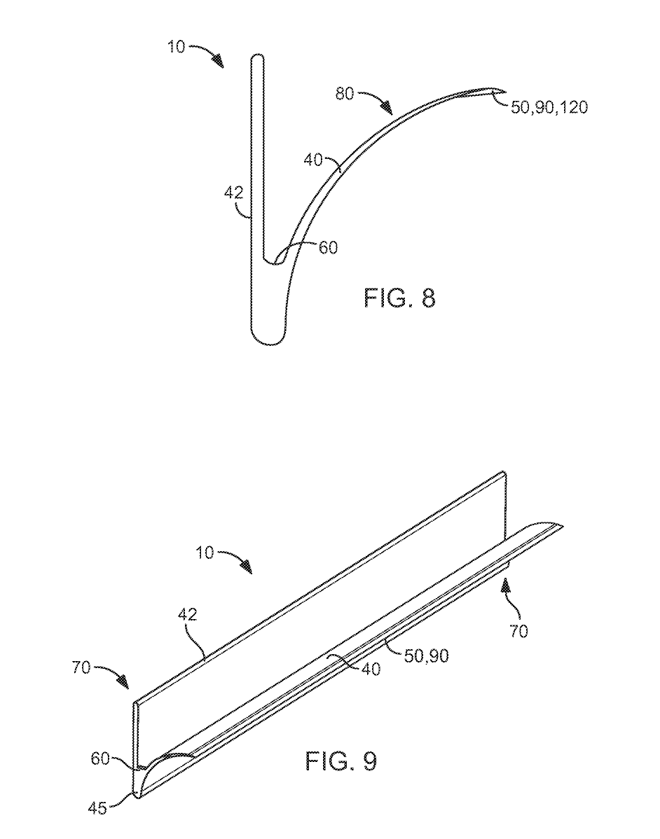

FIGS. 8 and 9 illustrate an embodiment wherein only one of the sidewalls 40 is resilient, and another sidewall 42 is substantially rigid and vertical. As such, the sidewall 42 contacts the object 20 substantially completely therealong, and the other sidewall 40 may flex temporarily toward the sidewall 42 to allow insertion of the debris catcher 10 between the objects 20.

The trough 30 of the debris catcher 10 may be manufactured from rubber, plastic, synthetic plastic, resin, poly vinyl, metal or the like. In order to fit the debris catcher 10 between two kitchen appliances 20, for example, the sidewalls 40 can be squeezed together as shown in FIG. 4. Once the debris catcher 10 is placed in the gap between the kitchen objects 20, its sidewalls 40 can be released by the user. The laterally resilient sidewalls 40 spring apart, resulting in a force exerted sidewise against both walls (e.g., 22 and 23 of FIG. 3) of the kitchen appliance or counter 20. The frictional and/or magnetic force prevents the debris catcher 10 from dropping between the objects 20. During kitchen use, the user can wipe crumbs 15 or any other debris 15 into the debris catcher 10, thereby simplifying kitchen use.

In order to empty the debris catcher 10, the trough 30 is pulled out horizontally and pushed down by hand, creating a slight incline downwards. Crumbs 15 may then be wiped out of the trough 30 and into a garbage bin (not shown) placed on a floor underneath the debris catcher 10. Alternately, the debris catcher 10 may be removed from between the objects 20, emptied, and then placed back between the objects 20.

The procedure for operating telescopic debris catcher 10 as shown in FIG. 5 is similar to that of the preferred embodiment, with the only difference being for allowing the user to adjust the length of the invention by pulling apart each debris catcher 10 until it reaches a desired length prior to installation.

While a particular form of the invention has been illustrated and described, it will be apparent that various modifications can be made without departing from the spirit and scope of the invention. For example the debris catcher 10 may be made in different colors, shapes and designs to match a user's kitchen appliances. Accordingly, this description is not intended to limit the scope of the present invention. The scope of the invention can only be interpreted using the appended claims.

What is claimed is:

1. A debris catcher for use between two objects, comprising a trough having at least two sidewalls, at least one being laterally-resilient, whereby the sidewalls may be temporarily pressed towards each other to fit between the two objects and then released to contact the objects and to hold the debris catcher substantially in place therebetween.

2. The debris catcher of claim 1 wherein at least one of the sidewalls includes at least one high-friction surface on an outermost portion thereof, each high-friction surface for frictionally contacting one of the objects.

3. The debris catcher of claim 1 wherein the trough includes a pair of lips at two ends thereof, whereby debris is retained within the trough.

4. The debris catcher of claim 1 wherein the trough is generally U-shaped in cross section.

5. The debris catcher of claim 1 wherein the trough is generally V-shaped in cross section.

6. The debris catcher of claim 1 wherein the trough is comprised of a material taken from the set of: rubber, plastic, synthetic plastic, resin, polyvinyl and metal.

7. The debris catcher of claim 1 wherein a portion of at least one sidewall includes an outwardly-curved section for contacting the objects.

8. The debris catcher of claim 2 wherein at least one of the outermost portions of each sidewall include a magnetic attaching means whereby the outermost portions of the at least one sidewall contact the objects to magnetically facilitate holding the debris catcher substantially in place between the two objects.

9. The debris catcher of claim 1 wherein at least one end of the trough includes connecting means such that the debris catcher may be connected co-axially to at least one other debris catcher to extend the length thereof.

10. The debris catcher of claim 1 wherein at least one sidewall tapers in thickness from a larger thickness towards the center of the trough to a thinner thickness towards each outermost portion.

11. The debris catcher of claim 1 wherein at least one sidewall includes stiffening sections proximate the center of the trough for decreasing the resiliency thereof towards the center thereof.

12. The debris catcher of claim 1 further including protective padding means fixed to an outermost portions of each sidewall.
